(19) United States
(12) Patent Application Publication
(10) Pub. No.: US 2012/0113046 A1
(43) Pub. Date: May 10, 2012

(54) Capacitive touch panel

(76) Inventor: Hirai AKIRA, Yongin-City (KR)

(21) Appl. No.: 13/067,477

(22) Filed: Jun. 3, 2011

(30) Foreign Application Priority Data
Nov. 8, 2010 (KR) 10-2010-0110570

(51) Int. Cl. G06F 3/044

(52) U.S. Cl. 345/174; 178/18.06

(57) ABSTRACT

A capacitive touch panel according to an exemplary embodiment includes: a transparent substrate; sensor electrode patterns including a plurality of touch sensors in the same layer, on the transparent substrate, and a plurality of sensor connectors, on the same layer as the plurality of touch sensors, the plurality of sensor connectors connecting the plurality of touch sensors in a column direction or a row direction; a first signal unit that supplies signals to the sensor electrode patterns in the column direction; and a second signal unit that supplies signals to the sensor electrode patterns in the row direction.

### BACKGROUND

1. Field

An exemplary embodiment relates generally to a capacitive touch panel.

2. Description of the Related Art

In general, capacitive touch panels are classified as a projection type or a surface type. Both types do not reduce visibility. Visibility is not reduced because an air layer is not required to be an insulation layer.

The projection type may be a structure having an X-axis sensor electrode pattern and a Y-axis sensor electrode pattern on both sides of a transparent substrate. The projection type may also be a structure having the sensor electrode patterns in a multilayer on one side of a transparent substrate. Furthermore, the projection type may be a self capacitance method that senses a change in capacitance by scanning the X-Y electrode. The projection type may also be a mutual capacitance method that senses a change in mutual capacitance of adjacent electrodes, using the X-Y electrode as a transmitting/receiving electrode.

The surface type senses a current change at a touch point. The surface type detects the position by forming a transparent conductive layer and a protective insulation layer throughout the sensor region on one side of a transparent substrate and applying waveforms having the same phase at the corners.

The disclosed information in the Background is only for enhancing the background of the described technology. Therefore, it may contain information that does not form the prior art already known to a person of ordinary skill in the art in this country.

### SUMMARY

The described technology has been made in an effort to provide a capacitive touch panel.

An exemplary embodiment provides a capacitive touch panel including: a transparent substrate; sensor electrode patterns including a plurality of touch sensors in the same layer, on the transparent substrate, and a plurality of sensor connectors on the same layer as the plurality of touch sensors, the plurality of sensor connectors connecting the plurality of touch sensors in a column direction or a row direction; a first signal unit that supplies signals to the sensor electrode patterns in the column direction; and a second signal unit that supplies signals to the sensor electrode patterns in the row direction.

The first signal unit may supply first signals to the touch sensors of the sensor electrode patterns for each column. Furthermore, the second signal unit may supply second signals to the touch sensors of the sensor electrode patterns for each row.

The first signals and the second signals may be sequentially or alternately supplied to the sensor electrode patterns.

Signals are supplied to all of the touch sensors of the sensor electrode patterns in a standby mode and the touch panel is changed into the sensing mode when the first signal unit and the second signal unit detect a change in the signals, such that the signals may be sequentially or alternately supplied to the touch sensors of the sensor electrode patterns for each column and each row.

A sensing period may be when signals are supplied one time to all of the columns and the rows of the sensor electrode patterns.

The sensing period may include a data process time.

The data process time may be disposed between the sensing periods.

The data process time may be disposed between signals supplied from the first signal unit and the second signal unit.

The first signal unit may include a plurality of first switching elements connected with the sensor electrode patterns for each column and a first detecting circuit connected with the plurality of first switching elements. Further, the second signal unit may include a plurality of second switching elements connected with the sensor electrode patterns for each row and a second detecting circuit connected with the plurality of second switching elements.

The capacitive touch panel may further include a main controller connected with the first detecting circuit and the second detecting circuit.

The first switching elements and the second switching elements may be sequentially or alternately turned on/off.

The capacitive touch panel may further include connection pads transmitting signals to the sensor electrode patterns, and connection wires connecting the connection pads with the sensor electrode patterns.

The capacitive touch panel may further include one or more printed circuit boards electrically connected with the connection pads.

In the capacitive touch panel, the transparent substrate may be divided into a plurality of sensor regions. Furthermore, the sensor electrode patterns independently operating may be disposed in the plurality of sensor regions.

### BRIEF DESCRIPTION OF THE DRAWINGS

FIG. 1 is a configuration of a capacitive touch panel according to a first exemplary embodiment.

FIGS. 2 and 3 are graphs showing signal waveforms that are applied to sensor electrode patterns of the capacitive touch panel of FIG. 1.

FIG. 4 is a layout view of a transparent substrate of the capacitive touch panel of FIG. 1.

FIG. 5 is a cross-sectional view showing a printed circuit board connected to the capacitive touch panel of FIG. 1.

FIG. 6 is a layout view of a transparent substrate of a capacitive touch panel according to a second exemplary embodiment.

### DETAILED DESCRIPTION

Korean Patent Application No. 10-2010-0110570, filed on Nov. 8, 2010, in the Korean Intellectual Property Office, and entitled “Capacitive Touch Panel,” is incorporated by reference herein in its entirety.

The inventive concept will now be described more fully hereinafter with reference to the accompanying drawings, in which exemplary embodiments of the invention are illustrated. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

Further, like reference numerals designate like constituent elements throughout the specification. Among several exemplary embodiments, exemplary embodiments other than a first exemplary embodiment will be described based on components other than those of the first exemplary embodiment.

The size and thickness of the components shown in the drawings are optionally determined for better understanding and ease of description, and the present invention is not limited to the examples shown in the drawings. In the drawings, the thickness of layers, films, panels, regions, etc., are exaggerated for clarity. Further, the thicknesses of some layers and regions are exaggerated in the drawings for better understanding and ease of description.

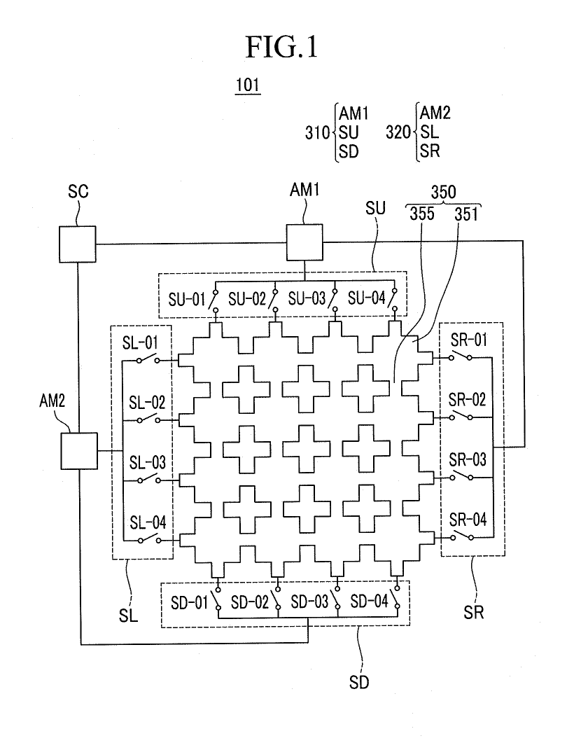

A capacitive touch panel 101 according to the first exemplary embodiment will be described with reference to FIGS. 1 to 5.

As shown in FIG. 1, the capacitive touch panel 101 includes sensor electrode patterns 350, a first signal unit 310, a second signal unit 320, and a main controller SC.

The sensor electrode pattern 350 is made of a transparent conductive material. The transparent conductive material may include one or more of ITO (Indium Tin Oxide), IZO (Indium Zinc Oxide), ZITO (Zinc Indium Tin Oxide), GITO (Gallium Indium Tin Oxide), In₂O₃ (Indium Oxide), ZnO (Zinc Oxide), GIZO (Gallium Indium Zinc Oxide), GZO (Gallium Zinc Oxide), FTO (Fluorine Tin Oxide), and AZO (Aluminum-Doped Zinc Oxide).

Furthermore, the sensor electrode patterns 350 each include a plurality of touch sensors 351 and a plurality of sensor connectors 355, connecting the plurality of sensors 351, in the column direction or the row direction. The plurality of touch sensors 351 and the plurality of sensor connectors 355 are formed on the same layer. As described above, since the sensor electrode patterns 350 have simple structures, the electrode patterns 350 may be formed by one photolithography process, or an ink-jet process and a printing process. The ink-jet and printing processes are relatively simple. Since the sensor electrode patterns 350 are made of transparent conductive materials, the sensor electrode patterns 350 may be formed on the same layer. Thus, it is possible to simplify the entire manufacturing process of the capacitive touch panel 101.

The first signal unit 310 and the second signal unit 320 supply signals to the sensor electrode patterns 350 in the column direction and the row direction.

The first signal unit 310 sequentially supplies first signals to the touch sensors 351 of the sensor electrode patterns 350 in the column unit. Furthermore, the second signal unit 320 sequentially supplies second signals to the touch sensors 351 of the sensor electrode patterns 350 in the row unit. The first signals and the second signals may be sequentially supplied or alternately supplied.

The first signal unit 310 includes a plurality of the first switching elements SU and SD, connected with the sensor electrode patterns 350 for each column, and a first detecting circuit AM1, connected with the plurality of the first switching elements SU and SD. The second signal unit 320 includes a plurality of second switching elements SL and SR, connected with the sensor electrode patterns 350 for each row, and a second detecting circuit AM2, connected with the plurality of the second switching elements SL and SR. The first detecting circuit AM1 and the second detecting circuit AM2 each may include an ammeter. The first detecting circuit AM1 and the second detecting circuit AM2 are connected, respectively, with the main controller SC.

In FIG. 1, although the first switching elements SU and SD and the second switching elements SL and SR are disposed in pairs, at both sides of the sensor electrode pattern 350, the first exemplary embodiment is not limited thereto. Thus, the first switching elements SU and SD and the second switching elements SL and SR may be disposed at one side.

The operational process of the capacitive touch panel 101, according to the first exemplary embodiment, will be described hereinafter in detail.

The capacitive touch panel 101 may operate only in a sensing mode or may operate in a standby mode and a sensing mode. Hereinafter, the present embodiments describe when the capacitive touch panel 101 operates in the standby mode and the sensing mode.

When the capacitive touch panel 101 is in the standby mode, signals are supplied to all the touch sensors 351 of the sensor electrode patterns 350. The plurality of the first switching elements SU and SD and the plurality of the second switching elements SL and SR are all kept on. In this state, when the first signal unit 310 or the second signal unit 320 detects a change in signals, the capacitive touch panel 101 is changed into the sensing mode.

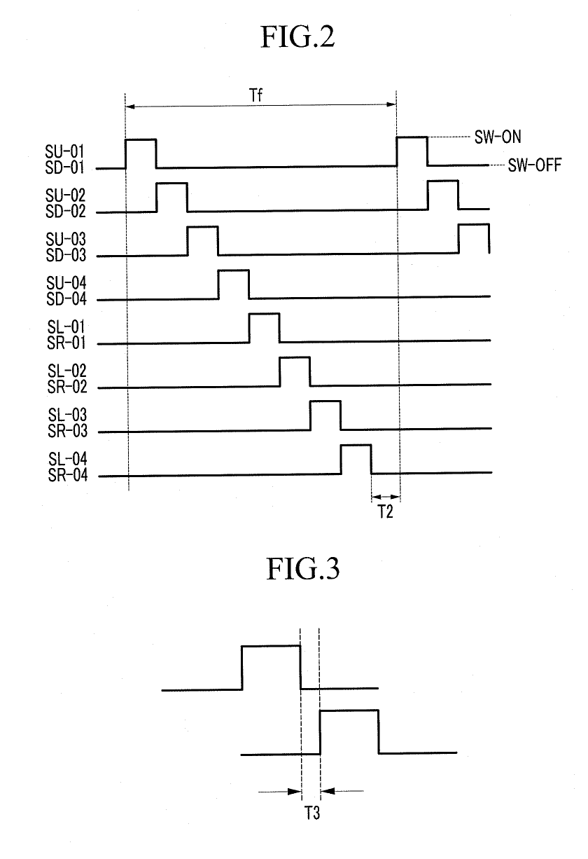

As shown in FIG. 2, when the capacitive touch panel 101 is changed into the sensing mode, the first signal unit 310 and the second signal unit 320, sequentially supply signals to the touch sensors 351 of the sensor electrode patterns 350 for each column unit and each row unit. In this process, one sensing period Tf occurs when signals are supplied one time to all the sensor electrode patterns 350 for each column and each row.

When the first switching elements SU-01 and SD-01 in the first column and row are turned on, the other switching elements are all turned off. The first switching elements SU-02 and SD-02 in the second column and row are turned on and the first switching elements SU-01 and SD-01 in the first column and row are turned off. As described above, the plurality of the first switching elements SU and SD are sequentially turned on one time, and then the plurality of the second switching elements SL and SR are sequentially turned on one time.

When there has been a contact on the capacitive touch panel 101 during the sensing period Tf, the detecting circuit AM1 and the second detecting circuit AM2 detects the signal variation, thereby determining the touch point.

In FIG. 2, although the plurality of first switching elements SU and SD and the plurality of second switching elements SL and SR are sequentially turned on and off, the first exemplary embodiment is not limited thereto. Therefore, the first switching elements SU and SD and the second switching elements SL and SR may be alternately turned on/off.

A data process time T2 may be set for each sensing period Tf. The sensing period Tf includes the data process time T2. All the switching elements SU, SD, SL, and SR are turned off during the data process time T2.

In FIG. 2, although the data process time T2 is set at the last of the sensing period Tf, the first exemplary embodiment is not limited thereto. Thus, as shown in FIG. 3, a data process time T3 may be disposed, between the signals supplied from the first signal unit 310 and the second signal unit 320, to the sensor electrode patterns. Thus, the switching elements SU, SD, SL, and SR are delayed by the data process time T3 and then sequentially or alternately turned on, respectively.

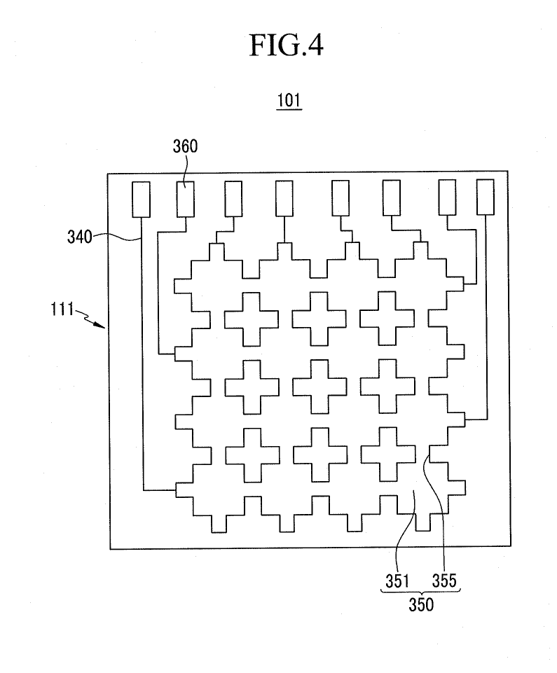

As shown in FIG. 4, the sensor electrode pattern 350 is disposed on a transparent substrate 111. The capacitive touch panel 101 further includes the transparent substrate 111. The transparent substrate 111 is where the sensor electrode patterns 350 are formed.

The transparent substrate 111 is made of a transparent insulating material such as glass, quartz, ceramic, and plastic. When the transparent substrate 111 is made of plastic, it may be a flexible substrate. The plastic that is available for the material of the transparent substrate 111 may be an insulating organic material, selected from a group of PES (polyethersulphone), PAR (polyacrylate), PEI (polyetherimide), PEN (polyethyelenen napthalate), PET (polyethyeleneterepthalate), PPS (polyphenylene sulfide), polyallylate, polyimide, PC (polycarbonate), TAC (cellulose triacetate), and CAP (cellulose acetate propionate).

The capacitive touch panel 101 may further include connection pads 360 for transmitting signals to the sensor electrode patterns 350 and connection wires 340 connecting the connection pads 360 with the sensor electrode pattern 350. The connection pads 360 are disposed at the edge of the transparent substrate 111. The connection pads 360 and the connection wires 340 may contain metallic substances in order to reduce resistance.

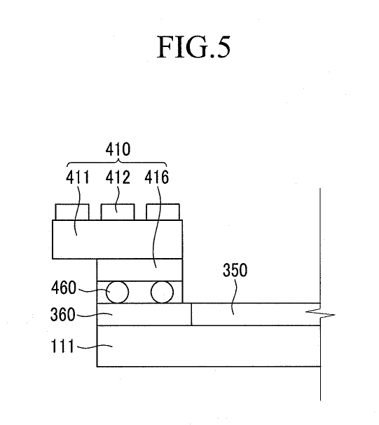

As shown in FIG. 5, the capacitive touch panel 101 may include one or more printed circuit board 410 electrically connected with the connection pads 360.

The printed circuit board 410 includes a circuit board main body 411, a circuit wire 412, and a connection electrode 416 formed on the circuit board main body 411.

The main controller SC, the first signal unit 310, and the second signal unit 320 may be disposed on the printed circuit board 410.

The printed circuit board 410 electrically connects the connection pads 360 of the transparent substrate 111 with the connection electrode 416 of the printed circuit board 410 through an anisotropic conductive film (ACF) 460. The anisotropic conductive film 460 includes an adhesive layer and conductive balls in the adhesive layer. The anisotropic conductive film 460 may further include various configurations known to those skilled in the art.

According to the configuration described above, the capacitive touch panel 101 can easily and stably detect touch points, with the simple structure similar to the surface type.

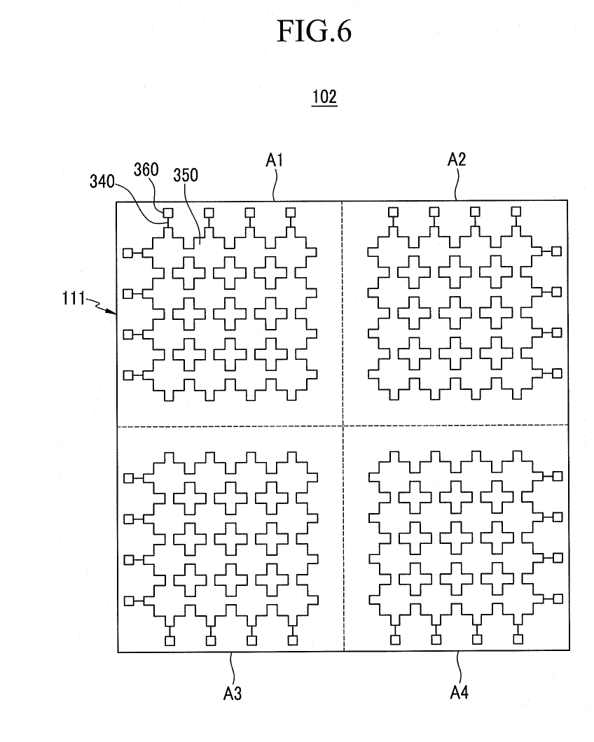

Hereinafter, a capacitive touch panel 102 according to the second exemplary embodiment will be described with reference to FIG. 6.

As shown in FIG. 6, in the capacitive touch panel 102 according to the second exemplary embodiment, a transparent substrate 111 is divided into a plurality of sensor regions A1, A2, A3, and A4.

Sensor electrode patterns 350 that independently operate are disposed in the plurality of sensor regions A1, A2, A3, and A4. The sensor electrode patterns 350 are formed in the same as in the first exemplary embodiment. Connection wires 340 and connection pads 360 which are connected with the sensor electrode patterns 350 may be formed on the transparent substrate 111.

According to the configuration, since the capacitive touch panel 102 can easily and stably detect touch points, with a simple structure, the sensing period can be reduced.

As the area of the capacitive touch panel 102 increases, the number of times the signals applied to the sensor electrode patterns 350 for each column and each row increases, which increases the entire sensing period. The increase in sensing period results in reduction of touch point recognition speed.

However, it is possible, as described in the second exemplary embodiment, to prevent the touch point recognition speed from reducing by dividing the transparent substrate into the plurality of sensors A1, A2, A3, and A4 and independently operating the sensor electrode patterns 350 for each of the sensor regions A1, A2, A3, and A4.

The sensing period was reduced to ¼ by dividing the transparent substrate into the four sensor regions A1, A2, A3, and A4 in FIG. 6. The second exemplary embodiment is not limited thereto and the sensor regions A1, A2, A3, and A4 may be further divided if necessary.

In a conventional capacitive touch panel, although the circuit load is small in a projection type, the manufacturing process is relatively complicated. In addition, although the structure of a sensor substrate is relatively simple in a conventional surface type, it is difficult to detect multi-touch points. Detection of multi-touch points are difficult because the touch points are detected by an analogue signal process.

According to exemplary embodiments, the capacitive touch panel can easily and stably detect touch points, with a simple structure. This simple structure may be similar to a surface type.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the prevent invention as set forth in the following claims.

What is claimed is:

1. A capacitive touch panel, comprising:
a transparent substrate;
sensor electrode patterns including a plurality of touch sensors, in the same layer, on the transparent substrate and a plurality of sensor connectors, on the same layer as the plurality of touch sensors, the plurality of sensor connectors connecting the plurality of touch sensors in a column direction or a row direction;
a first signal unit that supplies signals to the sensor electrode patterns in the column direction; and
a second signal unit that supplies signals to the sensor electrode patterns in the row direction.

2. The capacitive touch panel as claimed in claim 1, wherein:
the first signal unit supplies first signals to the touch sensors of the sensor electrode patterns for each column, and
the second signal unit supplies second signals to the touch sensors of the sensor electrode patterns for each row.

3. The capacitive touch panel as claimed in claim 2, wherein:
the first signals and the second signals are sequentially or alternately supplied to the sensor electrode patterns.

4. The capacitive touch panel as claimed in claim 2, wherein:
signals are supplied to all the touch sensors of the sensor electrode patterns in a standby mode, and
the touch panel is changed into the sensing mode when the first signal unit and the second signal unit detect a change in the signals, such that the signals are sequentially or alternately supplied to the touch sensors of the sensor electrode patterns for each column and each row.

5. The capacitive touch panel as claimed in claim 2, wherein:
a sensing period occurs when signals are supplied one time to all of the columns and the rows of the sensor electrode patterns.

6. The capacitive touch panel as claimed in claim 5, wherein:
the sensing period includes a data process time.

7. The capacitive touch panel as claimed in claim 6, wherein:
the data process time is disposed between the sensing periods.

8. The capacitive touch panel as claimed in claim 6, wherein:
the data process time is disposed between signals supplied from the first signal unit and the second signal unit.

9. The capacitive touch panel as claimed in claim 2, wherein:
the first signal unit includes a plurality of first switching elements connected with the sensor electrode patterns for each column and a first detecting circuit connected with the plurality of first switching elements, and
the second signal unit includes a plurality of second switching elements connected with the sensor electrode patterns for each row and a second detecting circuit connected with the plurality of second switching elements.

10. The capacitive touch panel as claimed in claim 9, further comprising:
a main controller connected with the first detecting circuit and the second detecting circuit.

11. The capacitive touch panel as claimed in claim 9, wherein:
the first switching elements and the second switching elements are sequentially or alternately turned on/off.

12. The capacitive touch panel as claimed in claim 1, further comprising:
connection pads transmitting signals to the sensor electrode patterns, and
connection wires connecting the connection pads with the sensor electrode patterns.

13. The capacitive touch panel as claimed in claim 12, further comprising:
one or more printed circuit boards electrically connected with the connection pads.

14. The capacitive touch panel as claimed in claim 1, wherein:
the transparent substrate is divided into a plurality of sensor regions, and
sensor electrode patterns in each of the plurality of sensor regions are independently operated.
